(19) United States
(12) Patent Application Publication
(10) Pub. No.: US 2015/0284648 A1
(43) Pub. Date: Oct. 8, 2015

(54) TEMPERATURE MONITORING IN A GASIFICATION REACTOR

(71) Applicant: SHELL OIL COMPANY, Houston, TX (US)

(72) Inventors: Ibrahim Kar, Koln (DE); Manfred Heinrich Schmitz-Goeb, Gummersbach (DE)

(21) Appl. No.: 14/435,773

(22) PCT Filed: Oct. 16, 2013
(86) PCT No.: PCT/EP2013/071589

§ 371 Date: Apr. 15, 2015

(30) Foreign Application Priority Data
Oct. 17, 2012 (EP) 12188806.9

(51) Int. Cl. C10J 3/76; G01K 13/02; C10J 3/72

(52) U.S. Cl. CPC C10J 3/76; C10J 3/723; G01K 13/02; C10J 2200/09; G01K 2013/024

(57) ABSTRACT

A gasification reactor for the partial combustion of a carbonaceous feed comprising a gasifier having a gasifier wall, and a method for monitoring temperature development in the gasifier. the gasifier wall comprises coolant lines. At least one of the coolant lines is a temperature monitoring line connected to a supply of a liquid coolant, in particular water. The temperature monitoring line comprises temperature measuring units for measuring temperature change over at least a section of the temperature monitoring line, where the coolant temperature is below the coolant boiling point.

The present invention relates to a gasification reactor for the production of syngas by partial combustion of a carbonaceous feed in a gasifier, wherein the gasification reactor comprises a pressure vessel and in this pressure vessel a membrane wall-enclosed process space and a device for monitoring the process temperature in the gasifier process space. The invention also relates to a method of monitoring a temperature in a gasifier of a gasification reactor. In the production of synthetic gas, or syngas, a carbonaceous feedstock, such as pulverized coal, biomass or oil, is partially oxidised in a gasification reactor of a gasification unit. During the process, the temperature in the gasification reactor can be as high as about 1300-1600° C., while the operating pressure is typically about 3-6.5 MPa. In a known gasifier concept, the process space is enclosed by a water/steam cooled membrane wall, while the process pressure is separately taken up by a pressure vessel, which is not exposed to the high temperatures.

The required temperature is different for each type of carbonaceous feed. To achieve the desired conversion rate of the feed to syngas, the temperature in the gasifier process space is a critical parameter which needs to be monitored closely to optimize process control. Due to the very high temperatures in the gasifier, these temperatures cannot be measured directly with the usual thermocouples or similar measurement devices.

In practice, heat in the gasifier process space of a gasification reactor is monitored indirectly by using the gasifier membrane wall comprising channels transporting a mixture of water and steam as a coolant. The mixture of water and steam in the membrane wall, which is next to the process space, absorbs gasifier heat, which increases the steam content of the mixture and by this produces valuable process steam. The amount of generated steam is indicative for the internal gasifier temperature. However, the cooling channels in the gasifier wall are typically part of a larger steam generating circuit including steam generating cooling channels upstream and/or downstream of the gasifier, so part of the measured steam amount is not generated by heat from the gasifier.

GB 2094955 discloses a vessel comprising an outer shell of carbon fibers held in a resin binder, a coolant circulation mechanism and control mechanism and an inner shell comprised of a refractory material. The control mechanism can be computer controlled and can be used to monitor and modulate the coolant which is provided through the circulation mechanism for cooling and protecting the carbon fiber and outer shell. The control mechanism is also used to locate any isolated hot spots which may occur through the local disintegration of the inner refractory shell.

It is an object of the invention to enable an operator to adequately monitor the temperature in the process space of a gasifier in a more accurate manner and thus be able to control this temperature by changing process variables to keep this temperature within the most favourable range.

The object of the invention is achieved with a gasification reactor for the partial combustion of a carbonaceous feed comprising a gasifier having a gasifier wall. The gasifier wall comprises coolant lines. At least one of the coolant lines is a temperature monitoring line connected to a supply of a liquid coolant and comprising one or more temperature measuring units which are configured to measure temperature change over at least a section of the temperature monitoring line, where the coolant temperature is below the coolant boiling point, at least under normal process conditions.

The object is also achieved with a method of monitoring the internal temperature in a gasifier under operating conditions. The gasifier has a gasifier wall with at least one temperature monitoring line. A liquid coolant, such as water, flows through the temperature monitoring line in a flow direction. The coolant has a temperature below its boiling temperature over at least a line section of the temperature monitoring line. The temperature of the coolant is determined at two or more measurement points of said line section. The increase of coolant temperature at the successive measurement points is used to calculate an estimation of the internal gasifier temperature.

The temperature at the inlet of the temperature monitoring line can be measured or can be known beforehand. In the last case, only one downstream temperature measurement unit needs to be used to determine an increase of temperature. However, the use of more temperature measuring units contributes to a more accurate determination of the coolant temperature.

The coolant is a subcooled liquid with a temperature below its boiling point at process conditions. In this context, the boiling temperature is the boiling temperature under process conditions in the coolant lines. In practice, these process conditions will typically include high coolant pressures, such as pressures of about 40-70 bar. Pressures outside this range can also be used, if so desired. Gasifier heat absorbed by a liquid coolant is fully converted to an increase in the coolant temperature. This is different from heat absorbed by the usual coolant of steam mixed with water, which mainly converts absorbed heat to a voluminous expansion.

The invention allows the measurement of the temperature of the gas in the process space (which can be, for example 1500° C.). Temperature measurement of the gasification space is known to be extremely difficult, and reliable and robust systems for commercial application are currently not available.

In operating units, sometimes the overall generated steam from the membrane wall is used as an indication of the gasifier process temperature. But this method is not very precise, as the steam comes from different heating surfaces which are not all directly related to the gasification chamber. With the present invention the process gas temperature in the gasifier is only monitored at the gasifier wall, so heat generated in heating surface sections downstream or upstream of the gasifier do not affect the determined temperatures. As a result, a substantially more accurate estimation of the gasifier process temperature can be calculated.

Measured increase of temperature with a liquid coolant is indicative of the temperature of the gasifier content. Given the coolant mass flow and flow rate and the thermo-conductive properties of the coolant line channel walls, the measured increase of coolant temperature can effectively be used to calculate a close estimate of the gasifier temperature.

Slag formation on the inside of the gasifier wall may thermally isolate the cooling lines and affect the relationship between inner gasifier temperatures and the coolant temperature. However, knowing the type of combusted hydrocarbon fuel, the extent of slag formation is highly predictable and can be taken into account.

The liquid coolant can for example be water. Operating pressures in coolant lines of gasifiers are generally high, e.g., in the range of 40-70 bar. With these pressures, the boiling temperature of the coolant water is above 250° C. The liquid water can for example be supplied to the inlet of the temperature monitoring lines with a temperature of, e.g., at most 240° C. or at most 230° C. or at most 220° C.

To improve its heat resistance, the gasifier wall can for example be built of parallel tubular coolant conduits interconnected to form a gastight wall structure. The tubular conduits can for instance be parallel vertical or helical conduits. One or more of these tubular lines may serve as the temperature monitoring line transporting the liquid coolant, while the other tubular lines are used for channelling a different type of coolant, which may partly be vaporized, such as a mixture of water and steam.

If the liquid coolant in the temperature monitoring lines is different from the coolant in other coolant lines, thermal stresses may be induced by differences in temperature. To reduce these stresses this temperature difference should preferably be limited. For instance the measured downstream temperature of the liquid coolant, e.g., measured at or near the outlet of the temperature monitoring line, can be at least 20 K, or at least 15 K or at least 10 K below the coolant boiling temperature. It is also possible to have a liquid coolant in the temperature monitoring line of about the same temperature as the partly vaporized coolant in the other lines, but at a higher pressure. For instance the temperature monitoring line may contain liquid water of 270° C. at a pressure of about 70 bar, while the other coolant lines contain a mixture of water and steam of 270° C. at a pressure of 50 bar.

Flow velocity and monitored flow path length can for example be configured in such a way that the increase of the coolant temperature ranges between 10-50 Kelvin, given the particulars of the gasifier and the generated internal gasifier heat.

The flow velocity of the coolant can for example be in the range of 1 to 5 m/sec, mainly depending on the length of the monitored coolant line section and the gasifier heat.

Optionally, the monitored coolant line may comprises at least one temperature measurement unit at its outlet and at least one further temperature measuring unit at its inlet. If the water temperature at the inlet and the water temperature at the outlet are both measured, the increase of the coolant temperature over the length of the channel can be determined accurately.

The gasifier temperature can be monitored even more accurately if the gasifier wall comprises more than one, e.g., at least three or four temperature monitoring lines equidistantly arranged over the wall of the gasifier.

In a specific embodiment, the temperature change is measured over a channel section which is fully within the gasifier wall. This way, any measured increase of temperature originates directly from gasifier heat. Preferably, the inlet and the outlet with the associated temperature measurement units are all part of the gasifier wall.

The one or more temperature monitoring lines may for instance be spiralling or run vertically upward or downward or may run in any other suitable direction.

The temperature measurement units can for example be conventional thermocouples, such as type K thermocouples.

The invention will be further explained under reference to the accompanying drawings, showing an exemplary embodiment of a gasification reactor according to the invention.

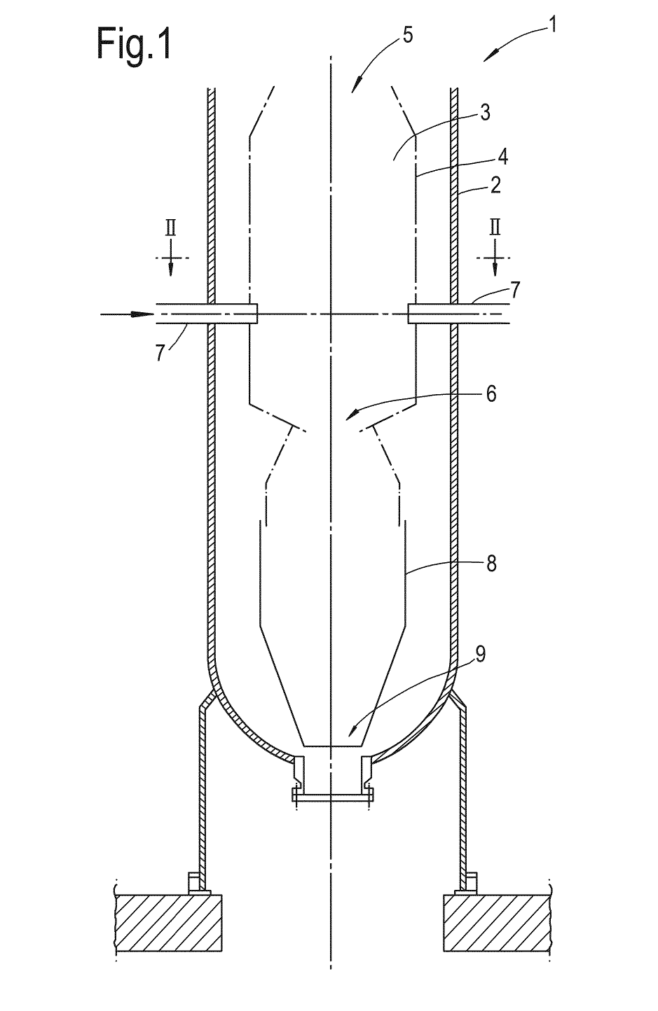

FIG. 1: shows schematically a gasification reactor in longitudinal cross section;

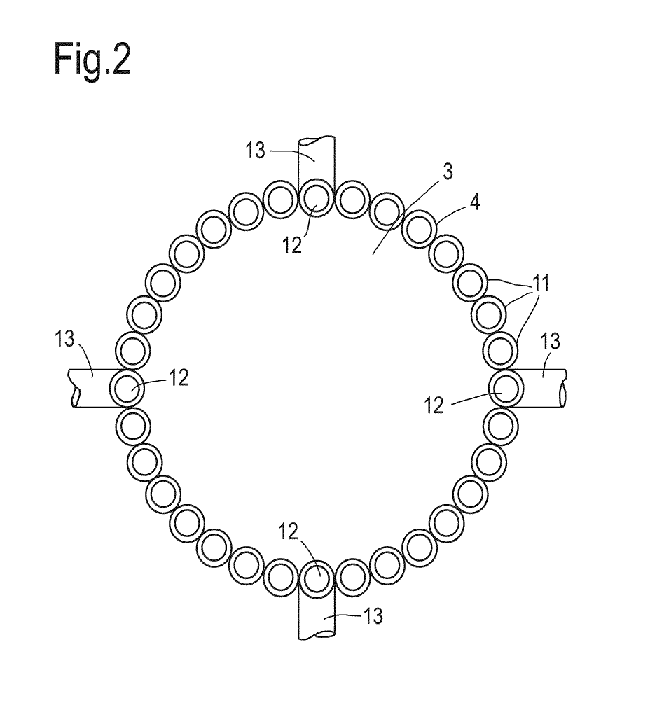

FIG. 2: shows the reactor of FIG. 1 schematically in cross section along line II-II in FIG. 1.

FIG. 1 shows an exemplary gasification reactor 1 for the production of syngas by gasification of a carbonaceous feed, such as pulverized coal. The gasification reactor 1 comprises a pressure vessel 2 encasing a gasifier 3. The gasifier 3 has a gasifier wall 4, a syngas outlet 5 at its top end and a slag outlet 6 at its bottom. Burners 7 extend through the gasifier wall 4.

In an alternative embodiment, the gasifier may have a single outlet at its lower end for discharging slag as well as produced syngas.

A hydrocarbon feed, such as a pulverized coal, is fed to the gasifier 3 via the burners 7 together with an oxygen containing gas, such as air or pure oxygen. The hydrocarbon feed is partially combusted to form syngas, which is discharged via the outlet 5 for further processing. Slag is discharged via the slag outlet 6 and collected in a water containing slag collection bath 8. Slag is removed from the slag collection bath 8 via a lower outlet 9.

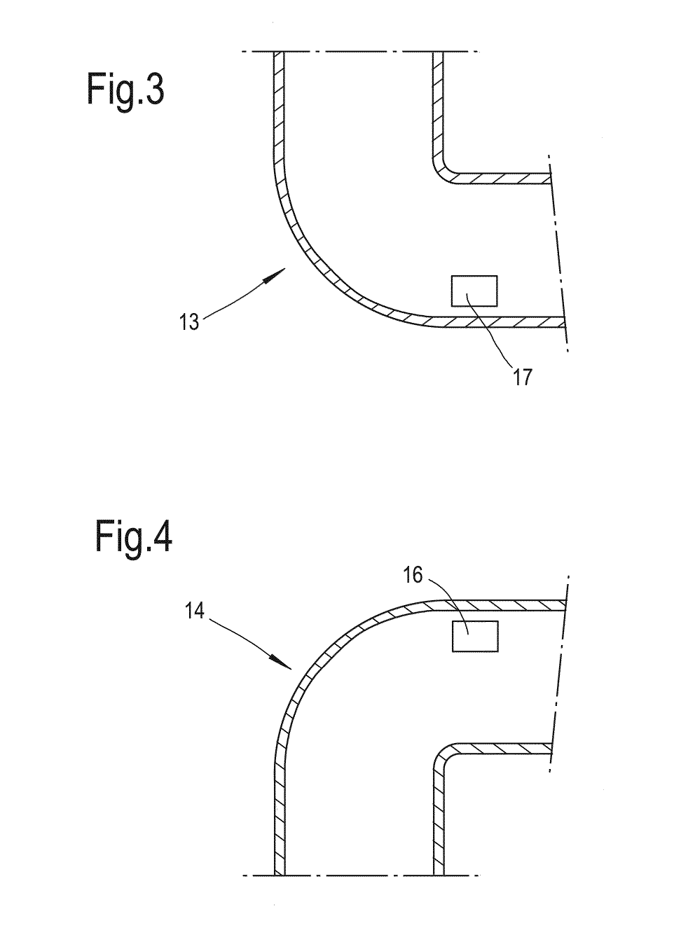

As shown in the cross section of FIG. 2, the gasifier wall 4 is formed by parallel tubular coolant conduits 11 interconnected to form a gastight wall structure, as shown in FIG. 2. Four equidistantly spaced tubular temperature monitoring lines 12 run between a lower inlet 13 and an upper outlet 14, shown in FIGS. 3 and 4, respectively. If so desired, any other suitable number of water channels can be used for the determination of the gasifier temperature. The inlets 13 are connected to a supply of sub-cooled water. Sub-cooled water has a temperature below its boiling point at operating pressure. The water temperature at the inlet can for example be about 230° C. or lower, e.g., about 220° C. or lower, or about 200° C. or lower at a pressure of 50-60 bar. The outlet 14 is connected to a water discharge. The temperature of the water at the outlet 14 may for instance be about 10-50° C. higher than the temperature at the inlet 13, dependent on the amount of absorbed internal gasifier heat.

FIGS. 3 and 4 show the inlet 13 and the outlet 14 respectively in cross section. Both are provided with a thermocouple 16, 17. The difference AT between the temperature Tₒᵤₜₗₑₜ measured by the outlet thermocouple 17 and the temperature Tᵢₙₗₑₜ measured by the inlet thermocouple 16 is indicative to the temperature T_{gasifier} of the gasifier contents.

1. A gasification reactor for the partial combustion of a carbonaceous feed comprising a gasifier having a membrane wall, which encloses the gasifier process space inside of the gasifier pressure vessel, wherein the membrane wall comprises coolant lines, at least one of the coolant lines being a temperature monitoring line connected to a supply of a liquid coolant and comprising one or more temperature measuring units for measuring temperature change in the process gas temperature over at least a section of the temperature monitoring line, where the coolant temperature is below the coolant boiling point.

2. A gasification reactor according to claim 1 wherein the temperature monitoring line comprises at least one further temperature measuring unit.

3. A gasification reactor according to claim 2 wherein at least one temperature measuring unit is provided at an inlet and at least one temperature measuring unit is provided at an outlet of the temperature monitoring line.

4. A gasification reactor according to claim 1, wherein the gasifier wall comprises a plurality of tubular temperature monitoring lines equidistantly arranged over the gasifier wall.

5. A gasification reactor according to claim 1, wherein the supply of a liquid coolant is a supply of water with a temperature below its boiling point at process conditions.

6. A gasification reactor according to claim 5 wherein the supply of a liquid coolant is a supply of water with a temperature of at least 50° C. below its boiling point at process conditions.

7. A gasification reactor according to claim 1, wherein the gasifier wall comprises a plurality of parallel tubular coolant conduits interconnected to form a gastight wall structure, wherein a number of the coolant conduits form said temperature monitoring lines, while the other coolant conduits are connected to an at least partly vaporized coolant.

8. A gasification reactor according to claim 7 wherein the at least partly vaporized coolant is a mixture of water and steam.

9. A method of monitoring internal temperature in the process space of a gasifier under operation conditions wherein the gasifier has a gasifier wall with at least one temperature monitoring line, wherein a liquid coolant flows through the temperature monitoring line in a flow direction, the coolant having a temperature below its boiling temperature over at least a line section of the temperature monitoring line, wherein the temperature of the coolant is determined at two or more measurement points of said line section, wherein the increase of coolant temperature at the consecutive measurement points is used to calculate an estimation of the internal gasifier temperature.
